(19) United States
(12) Patent Application Publication
(10) Pub. No.: US 2013/0101480 A1
(43) Pub. Date: Apr. 25, 2013

(54) BIO CHIP

(71) Applicants: Jeong Suong YANG, Yongin (KR); Bo Sung Ku, Suwon (KR)

(72) Inventors: Jeong Suong YANG, Yongin (KR); Bo Sung Ku, Suwon (KR)

(73) Assignee: Samsung Electro-Mechanics Co., Ltd.

(21) Appl. No.: 13/402,479

(22) Filed: Feb. 22, 2012

(30) Foreign Application Priority Data
Oct. 25, 2011 (KR) 10-2011-0109184

(51) Int. Cl. B01L 3/00

(52) U.S. Cl. 422/552

(57) ABSTRACT

There is provided a bio-chip. The bio-chip includes: a first substrate including a plurality of micro-wells formed in one surface thereof to a predetermined depth, the bottom face of each micro-well being hydrophilic and a lateral side thereof being hydrophobic; and a second substrate combined with the first substrate and including amounts of biomaterials inserted into the micro-wells, the amounts of biomaterials being provided at predetermined intervals.

### CROSS-REFERENCE TO RELATED APPLICATIONS

This application claims the priority of Korean Patent Application No. 10-2011-0109184 filed on Oct. 25, 2011, in the Korean Intellectual Property Office, the disclosure of which is incorporated herein by reference.

### BACKGROUND OF THE INVENTION

1. Field of the Invention

The present invention relates to a bio-chip, and more particularly, to a bio-chip having excellent measurement efficiency and measurement precision.

2. Description of the Related Art

Demands for a bio-medical instrument and/or bio assay techniques to rapidly diagnose different human diseases have recently increased. Accordingly, to facilitate the replacement of experiments or tests for specific diseases implemented in existing hospitals or laboratories and requiring a long period of time to undertake according to the related art, the development of bio-sensor and bio-chips capable of providing test results in a short period of time has been actively conducted.

A bio-sensor or bio-chip is an apparatus required not only in hospitals but also in other fields such as the pharmaceutical and cosmetics industries. In such fields, an examination method of testing a cellular reaction to a specific drug in order to assess or verify efficacy and safety (toxicity) thereof has been adopted. However, existing methods necessarily use an animal test subject or a large amount of reagent, thus leading to high costs and requiring a relatively long time to complete.

Accordingly, development of a novel bio-sensor or bio-chip providing rapid, accurate diagnoses while reducing costs required therefor is required.

The bio-chip may include a DNA chip, a protein chip and a cellular chip, in terms of types of bio-materials fixed to a substrate. In the early stages of bio-chip development, on the basis of interest in gaining human genetic information, DNA chips received considerable attention. However, since proteins as the base of life force, and cells comprised of combined proteins, as major parts of living organisms, have gradually come to attract a huge amount of interest, protein chips and cellular chips are currently receiving a large amount of interest.

Although protein chips incurred early developmental difficulties due to a problem of non-selective (that is, random) adsorption, several noticeable results regarding the foregoing have recently been reported.

On the other hand, cellular chips are an effective medium, applicable to a variety of applications such as the development of novel drugs, genomics, proteomics, etc., and are attracting public attention.

### SUMMARY OF THE INVENTION

An aspect of the present invention provides a bio-chip having excellent measurement efficiency and measurement precision.

According to an aspect of the present invention, there is provided a bio-chip, including: a first substrate including a plurality of micro-wells provided in one surface thereof to a predetermined depth, wherein the bottom face of each micro-well is hydrophilic and a lateral side thereof is hydrophobic; and a second substrate combined with the first substrate on which amounts of biomaterials to be inserted into the micro-wells are provided at predetermined intervals.

The first substrate may include a hydrophilic plate, and a hydrophobic plate having a plurality of through-holes formed therein at predetermined intervals, the hydrophobic plate being attached to the hydrophilic plate and having a plurality of the micro-wells formed by the through-holes.

The through-holes may have a circular or polygonal shape.

The hydrophilic plate may be formed of glass or polymer.

The hydrophilic plate may be formed of a transparent material.

The micro-well may have a depth of 1000 to 2000 μm.

The micro-well may have a diameter of 50 to 1000 μm.

The micro-well may include a reagent therein.

The bio-material may be dispersed in a porous dispersible material and provided on the second substrate.

The second substrate may include a plurality of micro-pillars provided at predetermined intervals and a biomaterial may be formed on one faces of respective micro-pillars.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating a bio-chip according to an embodiment of the present invention;

FIG. 2 is a schematic cross-sectional view illustrating a first substrate according to an embodiment of the present invention;

FIG. 3 is an exploded schematic perspective view illustrating a first substrate according to an embodiment of the present invention;

FIG. 4 is a cross-sectional view illustrating a second substrate according to an embodiment of the present invention;

FIG. 5 is a schematic cross-sectional view illustrating combination of a first substrate and a second substrate to configure a bio-chip according to an embodiment of the present invention; and

FIG. 6 is a schematic cross-sectional view illustrating a bio-chip according to another embodiment of the present invention.

### DETAILED DESCRIPTION OF THE EMBODIMENTS

Embodiments of the present invention will now be described in detail with reference to the accompanying drawings. The embodiments of the present invention maybe modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components

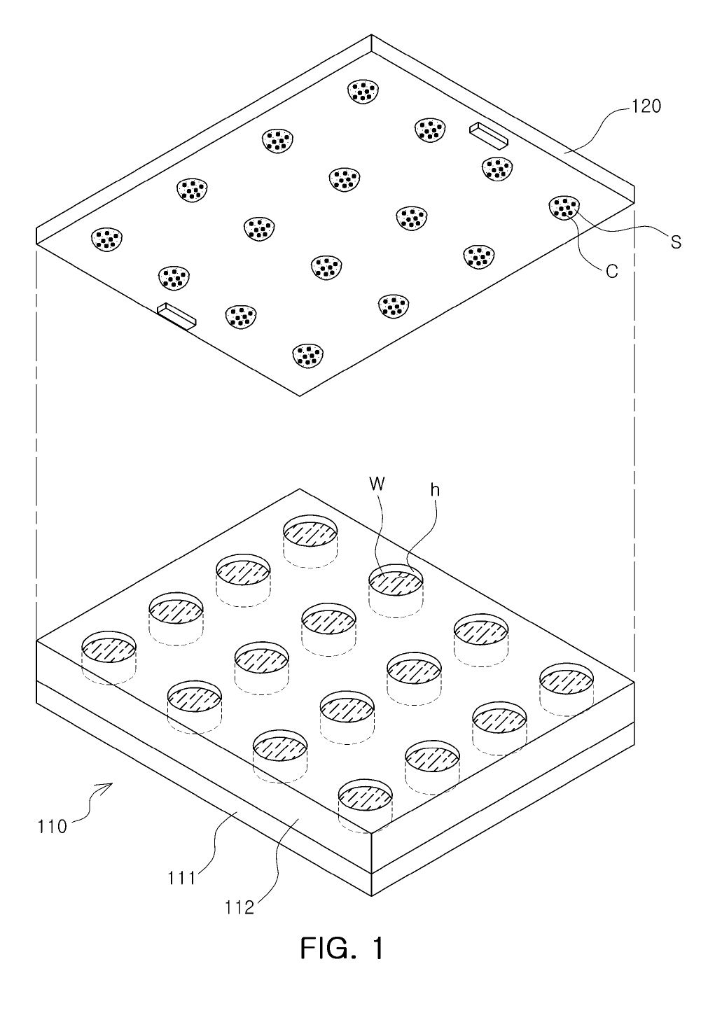

FIG. 1 is a schematic perspective view illustrating a bio-chip according to an embodiment of the present invention.

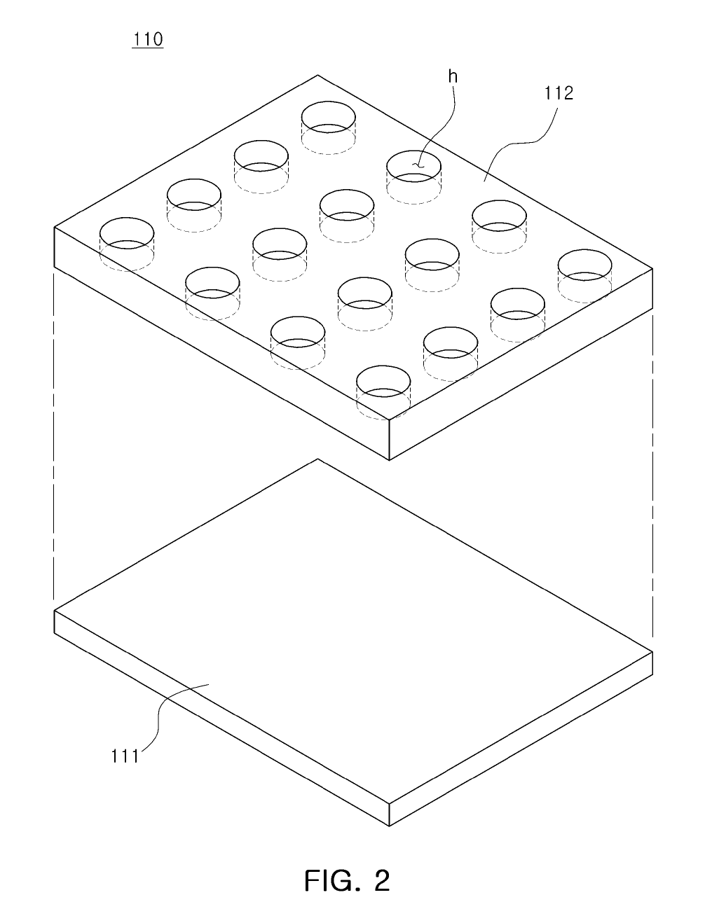

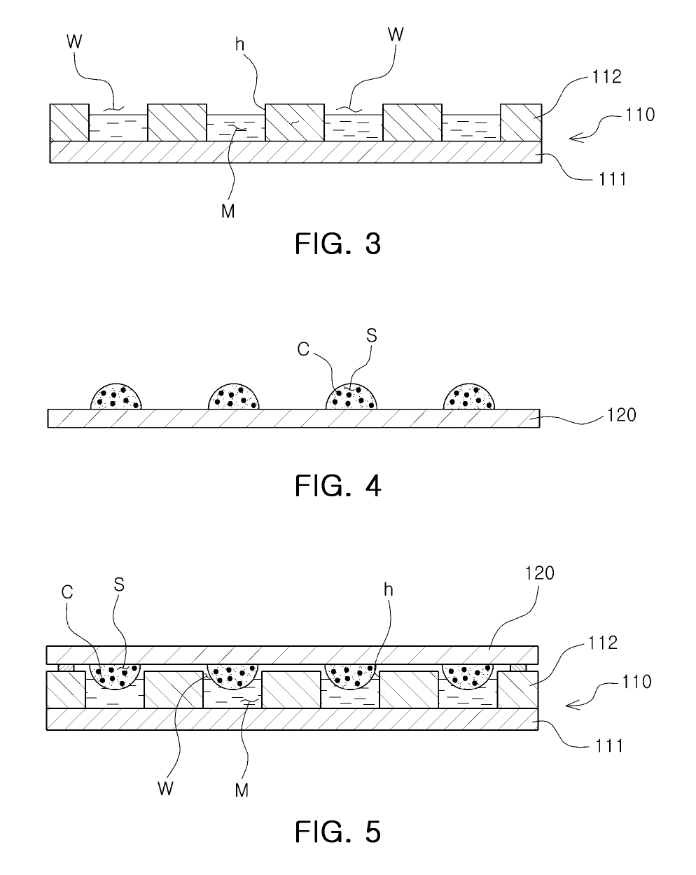

FIG. 2 is a schematic cross-sectional view illustrating a first substrate according to an embodiment of the present invention and FIG. 3 is an exploded schematic perspective view illustrating a first substrate according to an embodiment of the present invention. FIG. 4 is a cross-sectional view illustrating a second substrate according to an embodiment of the present invention. FIG. 5 is a schematic cross-sectional view illustrating combination of a first substrate and a second substrate to configure a bio-chip according to an embodiment of the present invention.

Referring to FIGS. 1 through 5, a bio-chip according to an embodiment of the present invention may include a first substrate 110 having a plurality of micro-wells W provided thereon, and a second substrate 120.

Referring to FIG. 2, the first substrate 110 according to the embodiment of the present invention may include a plurality of micro-wells W formed with a predetermined depth in one face of the substrate.

The micro-well W may be characterized in that a bottom face thereof is hydrophilic while a lateral side thereof may be hydrophobic.

Referring to FIG. 3, the first substrate 110 according to an embodiment of the present invention may be fabricated by attaching a hydrophobic plate 112 to a hydrophilic plate 111.

The hydrophilic plate 111 may have a flat planar shape and may be formed of a hydrophilic material. Without particular limitation, the hydrophilic plate 111 may be formed of a polymer or glass. As types of the polymer, for example, polymethyl methacrylate (PMMA), polycarbonate (PC) or polyethylene, a mixture thereof, or the like, maybe used without being limited thereto. The hydrophilic plate 111 may be formed by controlling a mixing ratio of polymer in order to obtain necessary characteristics thereof. According to the embodiment of the present invention, the hydrophilic plate may be formed of a transparent material.

According to an embodiment of the present invention, the hydrophobic plate 112 may be provided with a plurality of through-holes ‘h’ at predetermined intervals. The through-hole ‘h’ may be formed by penetrating top and bottom faces of the hydrophobic plate, wherein a depth of the through-hole may range from 1000 to 2000 μM, for example, without being limited thereto. A diameter of the through-hole ‘h’ may be in units of micrometers and, for example, the range from 50 to 1000 μm without being limited thereto.

A shape of the through-hole is not particularly limited, but maybe a circular or polygonal shape, or the like.

According to an embodiment of the present invention, the hydrophobic plate 112 may be attached to the hydrophilic plate 111. Referring to FIGS. 2 and 3, the hydrophobic plate 112 may be attached to the hydrophilic plate 111 and, via the through-holes ‘h’, a plurality of micro-wells W may be formed.

More specifically, the bottom face of the micro-well W may be formed by the hydrophilic plate 111 and a lateral side of the micro-well W may be formed via the through-hole ‘h’ in the hydrophobic plate 112.

The micro-well W may have a depth equal to a thickness of the hydrophobic plate 112 and a diameter equal to a diameter of the through-hole ‘h’. The depth and diameter of the micro-well W may be in units of micrometers. Without particular limitation, the depth of the micro-well may range from 1000 to 2000 μm, while the diameter of the micro-well may range from 50 to 1000 μm.

According to an embodiment of the present invention, the micro-well Wmay be formed and highly integrated on the first substrate 110. An interval between the micro-wells is not particularly limited, but may range from 50 to 1000 μm.

The micro-well W may include a reagent M introduced therein. The reagent M is not particularly limited, but may be, for example, a cell culture medium, a specific drug, any one of various aqueous solutions, etc.

The hydrophobic plate 112 may be formed of a hydrophobic material and, for example, a polymer without limitation thereto, as the polymer, polytetrafluoroethylene (PTFE), polystyrene, a mixture thereof, or the like, maybe used without limitation thereto. Moreover, by adjusting a mixing ratio of the polymer to attain necessary characteristics thereof, the hydrophobic plate 112 may be fabricated.

Referring to FIGS. 1 through 4, the second substrate 120 according to an embodiment of the present invention may be provided with a biomaterial C. The biomaterial C may be aligned on the second substrate 120 at a predetermined interval. The alignment of the biomaterial C may be provided to have a matrix form.

The biomaterial C may be provided on the second substrate 120 in response to a position of the micro-well W formed in the first substrate 110 and, in a case where it is combined to the first substrate 110, the biomaterial may be inserted in the micro-well W formed in the first substrate 110.

The biomaterial C may be formed and highly integrated on the second substrate 120 and an interval between the biomaterials is not particularly limited, but may range from 50 to 1000 μm.

According to an embodiment of the present invention, the biomaterial C may retain tissues thereof and be dispersed in a dispersible material S capable of maintaining functions thereof and attached to the second substrate 120.

Types of the biomaterial C are not particularly limited and may include, for example: nucleic acid sequences such as RNA, DNA, etc.; peptides; proteins; lipids; organic or inorganic chemical molecules; virus particles; prokaryotic cells; cell organelle, or the like. In addition, cell types are not particularly limited, but may include, for example: microorganisms; animal and/or plant cells; cancer cells; nerve cells; intravascular cells; immune cells, and so forth.

As the dispersible materials S, a porous material through which the reagent M such as different culture media, specific drugs, aqueous solutions, etc. can be penetrated may be used.

The dispersible material S may be, for example, a sol-gel, a hydro-gel, an alginate gel, an organogel, a xerogel, gelatin or collagen, without being limited thereto.

According to an embodiment of the present invention, the biomaterial C may be dispersed in a dispersible material S and attached to the second substrate 120 in the form of a three-dimensional structure. The biomaterial having the three-dimensional structure may be substantially similar to body environment, to thereby afford more precise test results.

The second substrate 120 may be formed of polymer, without being limited thereto. As examples of the polymer, polystyrene (PS), polycarbonate (PC), polyethylene or polystyrene maleic anhydride (PSMA), a mixture thereof or the like, may be used without being limited thereto.

Specifically, the polymer having a maleic anhydride functional group shows excellent bonding capability to a biomaterial. Accordingly, in a case in which the second substrate 120 is fabricated by regulating ratio of the polymer having the maleic anhydride functional group, adhesiveness of the biomaterial may be improved.

As shown in FIG. 5, when the first substrate 110 is combined with the second substrate 120, the biomaterial C provided on the second substrate 120 may be inserted into the micro-well W formed in the first substrate 110. The reagent M received in the micro-well W may be supplied to the biomaterial C. As a result, cell culture may be performed, and a variety of experimentations may be performed by analyzing biomaterial properties using the foregoing reagent.

According to an embodiment of the present invention, the hydrophilic plate may be formed of a transparent material. When the hydrophilic plate configuring the bottom face of the first substrate is formed of a transparent material, the biomaterial may be observed in a state in which the first substrate was combined with the second substrate.

In order to retain a cell function of the biomaterial C, a culture medium should be continuously fed thereto. Also, in order to assess a reaction of the biomaterial C to a specific drug, the specific drug should be provided to the biomaterial C. The specific drug may be provided thereto, to perform toxicity test, chemo-sensitivity and resistance tests of an anticancer drug, and so forth, for development of novel drugs.

Introduction of reagents into the micro-well may be performed by an ink-jet process, without being limited thereto. The micro-well may be a structure having a relatively small surface area and, when the reagent is introduced, bubbles may be generated on a contact face between the micro-well and the reagent.

In a case where the surface of the micro-well is entirely formed to be hydrophobic, introducing the hydrophilic reagent may cause relatively significant bubble formation. Specifically, bubbles formed at an edge formed by the bottom face and the lateral side of the micro-well may be increased. When bubbles are formed inside the micro-well, a reaction between the biomaterial and the reagent may be interrupted therewith and experimental results may be influenced thereby.

However, according to the embodiment of the present invention, the bottom face of the micro-well may be prepared using a hydrophilic plate. Since the bottom face of the micro-well has excellent affinity to the reagent, bubble formation may be prevented during introducing the reagent.

According to an embodiment of the present invention, the micro-well and the biomaterial may be aligned and highly integrated on the first substrate or the second substrate. Since the biomaterial is formed and highly integrated therewith, a variety of diagnoses may be concurrently performed and precision of test results may be enhanced. Moreover, after providing various type biomaterials, the biomaterials may be simultaneously subjected to a test of properties thereof to the same drug and/or diagnosis.

However, as the interval between the biomaterials and the micro-wells is relatively decreased, reaction between adjacent biomaterials may be increased and cross-contamination may occur between adjacent micro-wells. Specifically, when the micro-well is hydrophilic, affinity to the reagent may be favorable and may easily penetrate into the adjacent micro-wells, causing more serious cross-contamination.

However, according to an embodiment of the present invention, the lateral side of the micro-well may be formed using a hydrophobic plate. Therefore, diffusion possibility of the reagent may be reduced and penetration of the reagent into adjacent micro-wells along the lateral side thereof may be prevented. As a result, cross-contamination between the micro-wells may be prevented while reducing occurrence of experimental errors.

Further, with regard to reaction experimentations of the biomaterial against cell culture or reagents, a bio-chip may be present under environments including a wide range of temperatures such as room temperature or higher and/or lower for a long period of time. In general, the bio-chip may be present at a temperature ranging from −80□ to 25□.

The bio-chip may be deformed, causing deterioration in precision of experimentations, when the bio-chip is under a relatively low temperature or an environment including extremely varied temperature.

However, according to an embodiment of the present invention, the hydrophilic plate configuring the bottom face of the first substrate 110 may have a high temperature resistance, as compared to a hydrophobic material. Therefore, the substrate maybe not bent or deformed even under significant variation in temperature. As a result, precision of experimental results does not decrease even in a case in which the experimentations are executed in a wide range of temperatures, while improving measurement efficiency.

Since the bio-chip according to an embodiment of the present invention includes a first substrate and a second substrate, the first or second substrate may be independently separated and washed. Moreover, the reagent received in the micro-well may be periodically replaced.

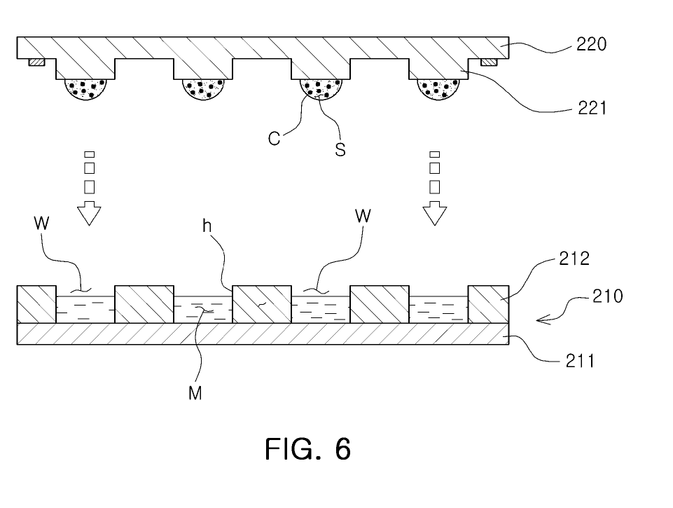

FIG. 6 is a cross-sectional view schematically illustrating a bio-chip according to another embodiment of the present invention. The following description will be given of explaining different constitutional elements from the foregoing embodiments while a detailed description of the same constitutional elements will be omitted.

Referring to FIG. 6, the bio-chip according to an embodiment of the present invention may include a first substrate 210 including a hydrophobic plate 212 attached to a hydrophilic plate 211, and a second substrate 220 that is combined with the first substrate.

The second substrate 220 may include a plurality of micro-pillars 221 arranged at predetermined intervals. Each micro-pillar 221 may be provided on a position corresponding to the micro-well W formed in the first substrate 210.

The micro-pillar 221 may indicate a structure protruded by a predetermined height from one face of the second substrate 220, and may be understood as a microfine rod or pin. The micro-pillar 221 may be a three-dimensional structure and may include the biomaterial C adhered to a protruded face of the micro-pillar 221.

The micro-pillar 211 may have a height in a wide range and, for example, the height may range from 50 to 500 μm, without being limited thereto. In addition, a shape of the micro-pillar is not particularly limited and may be, for example, a circular column, a polygonal column, etc.

The first substrate 210 according to an embodiment of the present invention may be fabricated by attaching a hydrophobic plate 212 to a hydrophilic plate 211.

As described above, according to an embodiment of the present invention, the hydrophobic plate 212 may include a plurality of through-holes arranged at predetermined intervals.

As shown in FIG. 6, the hydrophobic plate 212 may be attached to the hydrophilic plate 211 and a plurality of micro-wells W may be formed by the through-holes formed in the hydrophobic plate 212.

According to an embodiment of the present invention, the bottom face of the micro-well W may be formed of the hydrophilic plate 211, while a lateral side of the micro-well W may be formed of the hydrophobic plate 212.

The micro-well W may have a depth corresponding to a thickness of the hydrophobic plate 212 and a diameter corresponding to that of the through-hole. The diameter of the micro-well maybe in units of micrometers. Without particular limitation, the diameter of the micro-well W may range from 50 to 1000 μm. Moreover, an interval between adjacent micro-wells W may range from 50 to 1000 μm, without being limited thereto.

When the first substrate 210 is combined with the second substrate 220, the micro-pillar 221 formed in the second substrate 220 may be inserted into the micro-well W formed in the first substrate 210.

As described in the present embodiments, when the biomaterial C is provided in the micro-pillar 221, a binding efficiency between the biomaterial C and the reagent M may be enhanced. Furthermore, since the biomaterial C may be adhered to the protruded structure, that is, the micro-pillar 221, the biomaterial may be relatively easily rinsed after a variety of drug treatments.

As set forth above, the bio-chip according to an embodiment of the present invention may include micro-wells in a first substrate, wherein the micro-wells receive various reagents therein. After introducing the biomaterial into the micro-well, various reagents may be directly supplied to the biomaterial. Accordingly, cell culture may be undertaken and a variety of experimentations may be performed by analyzing biomaterial properties using the foregoing reagent.

According to an embodiment of the present invention, the micro-well and the biomaterial may be aligned and highly integrated on a first or second substrate. Since the biomaterial is highly integrated, a variety of diagnoses may be concurrently performed and precision of test results may be enhanced. Moreover, after forming various kinds of biomaterials, the biomaterials maybe simultaneously subjected to a test of characteristics to the same drug and/or diagnosis.

According to an embodiment of the present invention, biomaterial may be dispersed in a dispersible material and may be attached to the second substrate in the form of a three-dimensional structure. The biomaterial having a three-dimensional structure is substantially similar to a living body environment to thus afford precise test results.

According to an embodiment of the present invention, a hydrophilic plate may be formed of a transparent material. In a case in which the hydrophilic plate configuring the bottom face of the first substrate is formed of a transparent material, the biomaterial may be observed in a state in which the first substrate has been combined to the second substrate.

According to an embodiment of the present invention, a bottom face of the micro-well maybe hydrophilic. The bottom face of the micro-well exhibits relatively excellent affinity to a reagent, thus preventing bubble formation during introducing the reagent.

According to an embodiment of the present invention, the hydrophilic plate configuring the bottom face of the first substrate exhibits a strong temperature resistance, compared to a hydrophobic material. Therefore, the substrate may not be bent or deformed even under significant variation in temperature. Consequently, precision of experimental results does not decrease even in a case in which the experimentations are executed in a wide range of temperatures, while improving measurement efficiency.

According to an embodiment of the present invention, the lateral side of the micro-well may be hydrophobic. Therefore, a diffusion possibility of the reagent maybe reduced and penetration of the reagent into adjacent micro-wells along the lateral side of the micro-well may be prevented. As a result, cross-contamination between the micro-wells may be prevented while reducing occurrence of experimental errors.

In addition, according to an embodiment of the present invention, the bio-chip has relatively high temperature resistance and, therefore, may not be bent or deformed even when the bio-chip is placed under environments including a wide range of temperatures such as room temperature or higher and/or lower for a long period of time. Accordingly, even in a case in which experimentations are executed in a wide range of temperatures, precision of experimental results may not be degraded while improving measurement efficiency.

Further, since a bio-chip according to an embodiment of the present invention includes a first substrate and a second substrate, a first or second substrate may be independently separated and washed. Moreover, a reagent received in the micro-well may be periodically replaced.

According to an embodiment of the present invention, a micro-pillar may be provided on the second substrate and, when a biomaterial is formed in the micro-pillar, a binding efficiency between the biomaterial and the reagent may be relatively enhanced. Additionally, since the biomaterial may be adhered to a protruded structure, that is, the micro-pillar, the biomaterial may be relatively easily rinsed after a variety of drug treatments. Accordingly, measurement efficiency and precision of experimentation for the biomaterial may be enhanced.

While the present invention has been shown and described in connection with the embodiments, it will be apparent to those skilled in the art that modifications and variations can be made without departing from the spirit and scope of the invention as defined by the appended claims.

1. A bio-chip, comprising:
a first substrate including a plurality of micro-wells formed in one surface thereof to a predetermined depth, the bottom face of each micro-well being hydrophilic and a lateral side thereof being hydrophobic; and
a second substrate combined with the first substrate and including amounts of biomaterials inserted into the micro-wells, the amounts of biomaterials being provided at predetermined intervals,
wherein each of the micro-wells has a depth of 1000 to 2000 μm.

2. The bio-chip of claim 1, wherein the first substrate includes a hydrophilic plate, and a hydrophobic plate having a plurality of through-holes formed therein at predetermined intervals, the hydrophobic plate being attached to the hydrophilic plate and having a plurality of the micro-wells formed by the through-holes.

3. The bio-chip of claim 2, wherein the through-holes have a circular or polygonal shape.

4. The bio-chip of claim 2, wherein the hydrophilic plate is formed of glass or polymer.

5. The bio-chip of claim 2, wherein the hydrophilic plate is formed of a transparent material.

6. (canceled)

7. The bio-chip of claim 1, wherein each of the micro-wells has a diameter of 50 to 1000 μm.

8. The bio-chip of claim 1, wherein each of the micro-wells includes a reagent therein.

9. The bio-chip of claim 1, wherein the biomaterial is dispersed in a porous dispersible material and provided on the second substrate.

10. The bio-chip of claim 1, wherein the second substrate includes a plurality of micro-pillars provided at predetermined intervals and wherein the biomaterial is formed on one faces of respective micro-pillars.
